(19) United States
(12) Patent Application Publication
(10) Pub. No.: US 2025/0115261 A1
(43) Pub. Date: Apr. 10, 2025

(54) DISTRACTION MONITORING SYSTEM

(71) Applicant: GM Global Technology Operations LLC, Detroit, MI (US)

(72) Inventors: Matthew Edward Gilbert-Eyres, Rochester Hills, MI (US); Noah Stone, West Bloomfield, MI (US); Eric T. Hosey, Rochester Hills, MI (US); Russell A. Patenaude, Macomb Township, MI (US)

(73) Assignee: GM Global Technology Operations LLC, Detroit, MI (US)

(21) Appl. No.: 18/482,931

(22) Filed: Oct. 9, 2023

(51) Int. Cl. B60W 50/06; B60W 50/16; B60W 60/00

(52) U.S. Cl. CPC B60W 50/06; B60W 50/16; B60W 60/001; B60W 2556/50

(57) ABSTRACT

A vehicle distraction monitoring system includes a plurality of sensors coupled to a body of the vehicle and a vehicle processor that includes a distraction monitoring application, data processing hardware, and memory hardware storing vehicle data, and distraction zone data. The vehicle processor is configured to receive vehicle sensor data and distraction sensor data from the plurality of sensors and is configured to issue a distraction notification in response to one or more of the distraction zone data, the vehicle sensor data, and the distraction sensor data.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a distraction monitoring system.

Vehicles are typically equipped with monitoring systems that assist in maintaining driver attention during operation of the vehicle. For example, lane assist systems typically provide haptic and/or audio feedback to alert the driver when the vehicle is detected on an edge or outside of a driving lane. Further, navigation systems, either integrated within the vehicle or utilized from a third-party system, may provide alerts as to traffic events including, but not limited to, vehicles on the side of the road. These systems do not typically provide additional context or solutions to the driver and are primarily utilized in providing information without further action by the vehicle or a controller of the vehicle.

### SUMMARY

In some aspects, a distraction monitoring system for a vehicle includes a plurality of sensors coupled to a body of the vehicle and an audio array disposed within an interior cabin of the vehicle. The distraction monitoring system also includes a vehicle processor that includes a distraction monitoring application, data processing hardware, and memory hardware storing vehicle data, and distraction zone data. The vehicle processor is configured to receive sensor data from the plurality of sensors and is configured to issue a distraction notification in response to one or more of the distraction zone data and the sensor data. A network is communicatively coupled to the vehicle processor and configured to provide third-party data for the distraction monitoring application.

In some examples, the sensor data may include one or more of vehicle sensor data, impact avoidance data, and distraction data. The distraction monitoring application may be configured to anticipate the distraction data based on the distraction zone, and the distraction notification may include anticipated distraction data. The vehicle processor may be configured to heighten a sensitivity of the plurality of sensors in response to the vehicle approaching the distraction zone. Optionally, the third-party data may include points-of-interest and one or more roadside events. In some configurations, the distraction monitoring system may include a Global Positioning System (GPS) processor may include GPS data. The network may be configured to communicate the points-of-interest, the one or more roadside events, and GPS data to the vehicle processor, and the vehicle processor may be configured to update the distraction zone data in response to receiving one or more of the points-of-interest, the one or more roadside events, and GPS data. The distraction monitoring application may be configured to update the distraction zone based on the updated distraction zone data.

In some aspects, a distraction monitoring system includes a plurality of sensors coupled to a body of a vehicle and an audio array disposed within an interior cabin of the vehicle. The distraction monitoring system also includes a vehicle processor that includes a distraction monitoring application, data processing hardware, and memory hardware storing vehicle data, and distraction zone data. The vehicle processor is configured to receive distraction data from the plurality of sensors and is configured to issue a distraction notification in response to one or more of the distraction zone data and sensor data received from the plurality of sensors.

In some examples, the distraction monitoring system may include a network that includes a communication server that is communicatively coupled to the vehicle processor, the communication server configured to transmit third-party data to the vehicle processor. The vehicle processor may be configured to respectively update the distraction zone and heighten a sensitivity of the plurality of sensors in response to the third-party data received. Optionally, the distraction monitoring system may include a GPS processor that may include GPS data. The network may be configured to communicate the third-party and GPS data to the vehicle processor, and the vehicle processor may be configured to update the distraction zone data in response to receiving at least one of the third-party data and GPS data.

In some configurations, the distraction monitoring application may be configured to anticipate the distraction data from the plurality of sensors based on the distraction zone data, and the distraction notification may include anticipated distraction data. The distraction data may include one or more points-of-interest, and the distraction monitoring application may be configured to issue an audio notification via the audio array identifying the one or more points-of-interest. In some examples, the distraction monitoring application may be configured to execute an autonomous function of the vehicle in response to the distraction data.

In yet other aspects, a vehicle distraction monitoring system includes a plurality of sensors coupled to a body of the vehicle and a vehicle processor that includes a distraction monitoring application, data processing hardware, and memory hardware storing vehicle data, and distraction zone data. The vehicle processor is configured to receive vehicle sensor data and distraction sensor data from the plurality of sensors and is configured to issue a distraction notification in response to one or more of the distraction zone data, the vehicle sensor data, and the distraction sensor data.

In some examples, the vehicle distraction monitoring system may include a network that may be communicatively coupled to the vehicle processor. The vehicle processor may be configured to receive roadside event data and point-of-interest data from the network and, in response, may update the distraction zone data. Optionally, the vehicle processor may be configured to monitor driving patterns to detect a distraction indicator, and the vehicle processor may be configured to issue one or more of audible alerts and haptic alerts in response to a detected distraction event. The vehicle processor may be configured to determine a distraction zone based on one or more of the distraction zone data, the point-of-interest data, and the roadside event data, and the vehicle processor may be configured to determine when the vehicle is outside of the distraction zone and may be configured to decrease a sensitivity of the plurality of sensors in response to the vehicle being outside of the distraction zone.

### BRIEF DESCRIPTION OF THE DRAWINGS

The drawings described herein are for illustrative purposes only of selected configurations and are not intended to limit the scope of the present disclosure.

FIG. 1 is a schematic example of a vehicle traveling along a road proximate to a series of vehicles on a side of the road according to the present disclosure;

FIG. 2 is a partial perspective view of an interior cabin of a vehicle with a driver receiving audio output from a distraction monitoring system according to the present disclosure;

FIG. 3 is a functional block diagram of a distraction monitoring system according to the present disclosure;

FIG. 4 is a flow diagram of a distraction monitoring system according to the present disclosure; and

FIG. 5 is a continuation of the flow diagram of FIG. 4.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

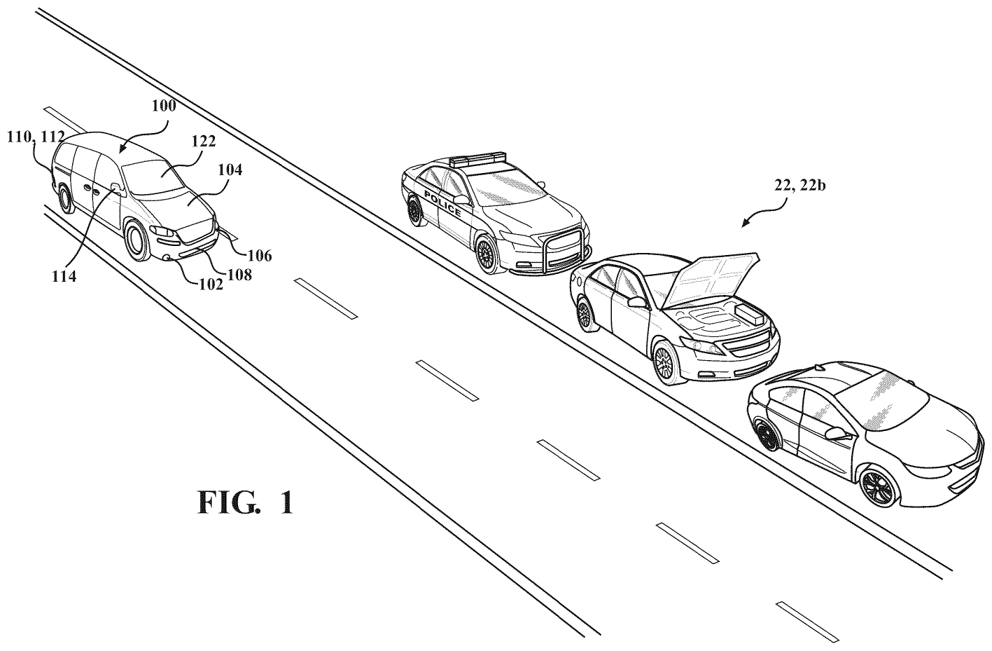

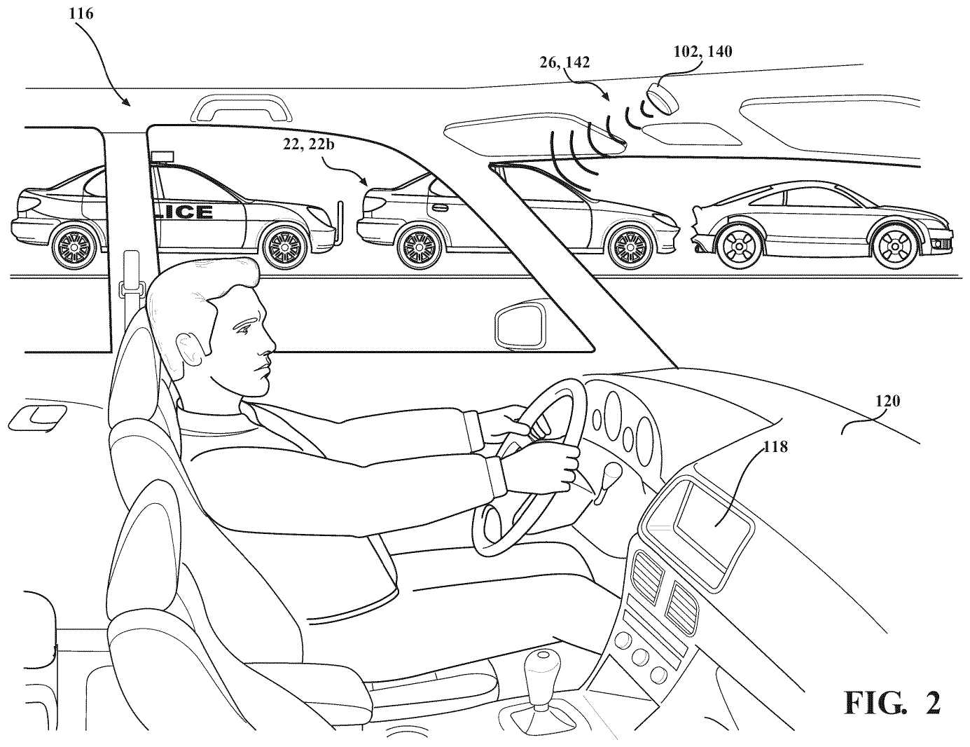

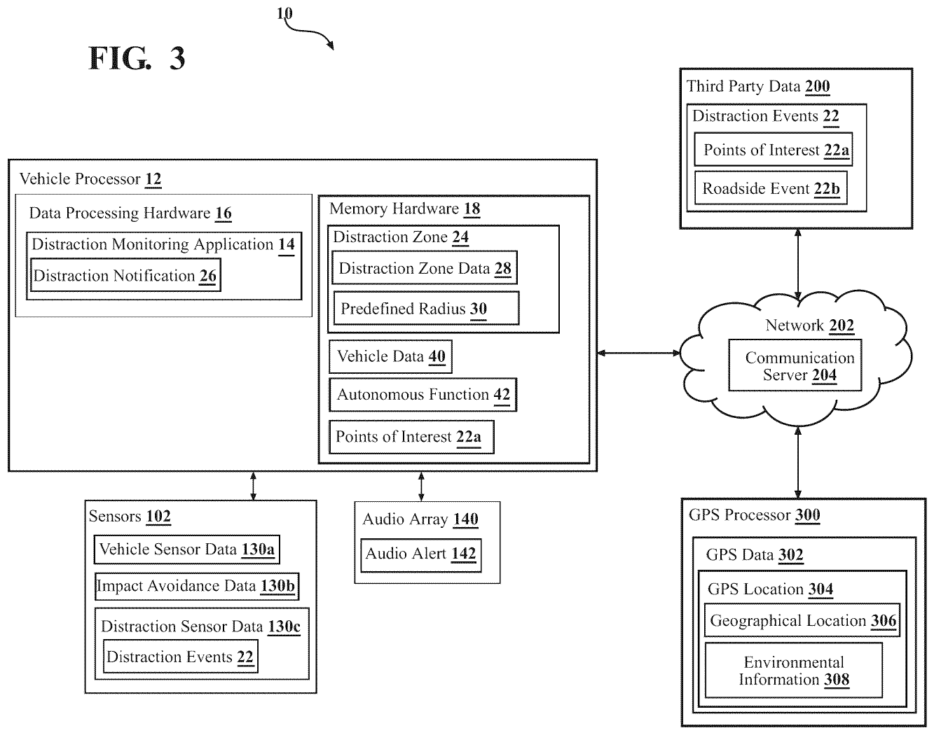

Referring to FIGS. 1-5, a distraction monitoring system 10 for a vehicle 100 includes a vehicle processor 12 with a distraction monitoring application 14, data processing hardware 16, and memory hardware 18. The vehicle processor 12 is communicatively coupled to a plurality of sensors 102 coupled to a body 104 of the vehicle 100, described in more detail below. In some aspects of the disclosure, the vehicle 100 is an electric vehicle (EV) with autonomous or semi-autonomous capabilities. Additionally or alternatively, the vehicle 100 may be configured with an internal combustion engine (ICE). In other aspects, the vehicle 100 may be a hybrid vehicle incorporating both EV and ICE components and capabilities.

The vehicle body 104 may be generally divided into a vehicle forward portion 106 proximate a front bumper 108 of the vehicle body 104 and a vehicle rearward portion 110 proximate a rear bumper 112. As depicted in FIG. 1, the vehicle 100 includes the plurality of sensors 102 that may be incorporated with various elements of the vehicle body 104 including, but not limited to, rearview mirrors 114, the front bumper 108, and the rear bumper 112. The sensors 102 may include, but are not limited to, proximity sensors, light detection and ranging (LIDAR) sensors, and imaging sensors that may be incorporated as part of the vehicle body 104.

With specific reference to FIGS. 1-3, an interior cabin 116 of the vehicle 100 is defined by the body 104 and includes a display device 118. The interior cabin 116 may be equipped with one or more of the plurality of sensors 102 including, but not limited to, an imager 102. It is also contemplated that the imager 102 may be positioned on exterior rearview mirrors 114. The imager 102 is configured to capture distraction indicators 20 within the interior cabin 116 in particular reference to a driver or operator of the vehicle 100. The vehicle processor 12 is also configured to monitor driving patterns to detect one or more distraction indicators 20.

The display device 118 may be situated at a dashboard 120 of the vehicle 100 and is configured to display information related to the vehicle 100 to an occupant, including a driver or operator, of the vehicle 100. In some aspects, the display device 120 maybe a heads-up display (HUD) integrated with a windshield 122 of the vehicle 100. In other examples, the display device 120 may be a tablet device integrated with the dashboard 120 and configured with capacitive sensors that provide for operative functions of the display device 120. As described in more detail below, the display device 120 may display information pertaining to distraction events 22 and/or a distraction zone 24 to the operator before, during, and after entering, the distraction zone 24 or approaching the distraction event 22.

The distraction monitoring system 10 is communicatively coupled to the display device 120 and the sensors 102. For example, the distraction monitoring system 10 may display the distraction monitoring application 14 on the display device 120, as described below. The sensors 102 may be integrated as part of the distraction monitoring system 10, such that the sensors 102 are communicatively coupled with the distraction monitoring application 16. The distraction monitoring system 10 is integrated with the vehicle 100. The sensors 102 are configured to send sensor data 130 to the vehicle processor 12 to assist in monitoring the distraction indicators 20 within the vehicle 100 and distraction events 22 along a route of the vehicle 100.

The sensor data 130 may include one or more of vehicle sensor data 130a, impact avoidance data 130b, and distraction data 130c. The vehicle sensor data 130a pertains to data gathered by the sensors 102 relative to the vehicle 100 traveling along the route. The vehicle sensor data 130a may include, but is not limited to, lane tracking data. For example, the sensors 102 may detect when the vehicle 100 approaches or crosses a driving lane along the route and sends the detected vehicle sensor data 130a to the vehicle processor 12. The impact avoidance data 130b may be informed by the vehicle sensor data 130a and is generally defined by the sensors 102 detecting a potential impact event. The potential impact event may be defined as an event between the vehicle and a third-party object (e.g., a third-party vehicle) that may result in an impact if unaddressed.

For example, if the operator of the vehicle 100 is distracted, then the sensors 102 may detect the potential impact event and send the impact avoidance data 130b to the vehicle processor 12. In response to receiving the impact avoidance data 130b, the vehicle processor 12 may issue an audio alert and/or a haptic alert to the operator of the vehicle 100 via the distraction monitoring application 14 in response to the detected distraction indicator 20. The distraction data 130c may be gathered by the sensors 102 disposed within the interior cabin 116 of the vehicle 100. For example, the distraction data 130c may include, but are not limited to, the operator or another occupant making an audible announcement to observe an object or event outside of the vehicle 100. The audible announcement may be detected by a microphone 102b within the vehicle 100 and transmitted to the vehicle processor 12.

Additionally or alternatively, the imager 102 may detect the distraction data 130c by visually capturing image data of the operator exhibiting distracted indicators 20. The distraction data 130c is communicated with the distraction monitoring application 14, and the distraction monitoring application 14 may issue a distraction notification 26. The distraction notification 26 may include the audio alert and/or the haptic alert, mentioned above, and may also include a visual notification that may be displayed on the display device 118. In some examples, the distraction notification 26 may be audibly issued over an audio array 140 of the vehicle 100.

In some instances, the distraction monitoring application 14 is configured to anticipate the distraction data 130c, as described in more detail below, and issues the distraction notification 26, including the anticipated distraction data 130c. For example, the distraction monitoring application 14 may detect that the vehicle 100 is approaching a distraction zone 24 based on distraction zone data 28 stored in the memory hardware 18. The distraction monitoring application 14 may preemptively issue the distraction notification 26 to prevent the distraction indicators 20 that may otherwise be detected by the sensors 102 and gathered as distraction data 130c.

The data processing hardware 16 of the vehicle processor 12 is configured to perform operations of the distraction monitoring system 10, and the memory hardware 18 is in communication with the data processing hardware 16 and stores instructions that when executed on the data processing hardware 16 causes the data processing hardware 16 to perform the operations. The operations performed by the data processing hardware 16 may include initiating the distraction monitoring application 14. The distraction monitoring application 14 may be configured as a user-facing interface of the distraction monitoring system 10. The distraction monitoring application 14 receives and incorporates the sensor data 130 from the plurality of sensors 102 and vehicle data 40 that is stored in the memory hardware 18. The vehicle controller 12 may display the distraction monitoring application 14 on the display device 120 and, as described herein, the distraction monitoring application 14 may present notifications 26 on the display device 120 in response to a distraction event 22.

The vehicle processor 12 is communicatively coupled with the audio array 140 disposed within the interior cabin 116 of the vehicle 100. The distraction monitoring application 14 may issue a notification 26 via the audio array 140 to provide audio alerts 142 to the driver or operator of the vehicle 100 in response to a determined distraction event 22. A distraction event 22 may be categorized by an external or internal distraction that may otherwise influence the driver to shift attention during operation of the vehicle 100. For example, the sensors 102 may detect an internal distraction event 22 based on audio detected by the audio array 140, as generally mentioned above. As described herein, the distraction event 22 is an external event relative to the vehicle 100 that may be detected by the plurality of sensors 102 and/or may be received as third-party data 200 from a network 202. The distraction event 22 may be stored as part of the distraction data 130c. The distraction event 22 is described in more detail below.

The vehicle processor 12 stores the distraction zone data 28 within the memory hardware 18, which may be utilized to define a distraction zone 24 relative to the distraction event 22, and the vehicle 100. The distraction zone 24 may be a pre-defined radius 30 around the vehicle 100 in which the distraction event 22 may overlap. In some instances, the distraction event 22 may include points-of-interest 22a that are external to the vehicle 100 that may be stored in the memory hardware 18 or received by the vehicle processor 12 from the network 202. Points-of-interest 22a may include, but are not limited to, scenic overlooks or landscapes, billboards, seasonal decorations, cityscapes, landmarks, and other fixed points that may draw the attention of an occupant of the vehicle 100. In other instances, the distraction event 22 may include a roadside event 22b, described below. In some examples, the distraction data 130c may include one or more points-of-interest 22a, and the distraction monitoring application 14 may be configured to issue an audio alert 142 via the audio array 140 that identifies the one or more points-of-interest 22a. Thus, the distraction monitoring application 14 may prevent the distraction indicators 20 by providing the notification 26, via the audio alert 142, while monitoring the driver for distraction indicators 20.

The distraction monitoring system 10 may also interconnect the vehicle processor 12 with a Global Positioning System (GPS) processor 300 in addition to the network 202. The GPS processor 300 is communicatively coupled with the network 202 to provide GPS data 302, such as a GPS location 304 of the vehicle 100 to the distraction monitoring system 10. For example, the GPS data 302 may include a surrounding geographical location 306 corresponding to a route of the vehicle 100 and environmental information 308 relative to the geographical location 306. The GPS data 302 is monitored both during transit and in a stationary position. The environmental information 308 may include information, including but not limited to, road conditions, road curvatures, road grade, building locations, and topographical information. It is generally contemplated that the environmental information 308 may be communicated to the vehicle processor 12 to update and inform the points-of-interest 22a that may be utilized to define the distraction zone 24. For example, the network 202 may be configured to communicate the points-of-interest 22a, roadside events 22b, and the GPS data 302 to the vehicle processor 12, and the vehicle processor 12 may be configured to update the distraction zone data 28 in response to receiving one or more of the points-of-interest 22a, the roadside events 22b, and the GPS data 302. Further, the distraction monitoring application 14 may be configured to update the distraction zone 24 based on the updated distraction zone data 28.

The environmental information 308 may also include additional information related to the surroundings of the vehicle 100 that may be advantageous to transmit to the vehicle processor 12. The distraction monitoring system 10 may query the GPS processor 300 via the network 202 for the GPS data 302 in response to detection of a distraction event 22, as described below. The GPS processor 300 transmits the geographical location 306 and the environmental information 308 over the network 202 to the vehicle processor 12. The network 202 may include a communication server 204 communicatively coupled to the vehicle processor 12 to send and receive signals. For example, the communication server 204 may obtain the GPS data 302 from the GPS processor 300 and communicate the GPS data 302 directly with the operator or driver of the vehicle 100. In some examples, the communication server 204 may also communicate the GPS data 302 to the vehicle processor 12 for analysis as part of the distraction monitoring system 10.

For example, the vehicle 100 may be traveling along a route that has a scenic view. The GPS processor 300 may transmit that environmental information 308 to the vehicle processor 12 via the network 202 indicating a point-of-interest 22a that may be distracting to the operator of the vehicle 100. The network 202 may utilize the communication server 204 to communicate with the operator the environmental information 308 and provide a recommendation to remain focused on the road. The sensors 102 within the vehicle 100 monitor the driver to detect any potential distraction indicators 20. If a distraction indicator 20 is detected, the distraction monitoring application 14 may issue a distraction notification 26 including one or more of an audio alert, a haptic alert, and a visual alert.

It is further contemplated that the distraction monitoring system 10 may recommend initiating an autonomous function 40 of the vehicle 100 in response to one or both of the point-of-interest 22a and/or the distraction indicator(s) 20 detected. For example, the audio alert 142 of the distraction notification 26 may notify the operator that the vehicle 100 will approach a point-of-interest 22a and recommend executing the autonomous function 42. The operator may provide audio or tactile feedback to initiate the autonomous function 42. Alternatively, the operator may dismiss the prompt, via the distraction notification 26, to execute the autonomous function 42. In the event that the operator dismisses the distraction notification 26, the distraction monitoring system 10 continues to monitor the operator for potential distraction indicators 20 with heightened sensitivity of the sensors 102 throughout the distraction zone 24.

The distraction monitoring system 10 is configured to increase and decrease the sensitivity of the sensors 102 based on the distraction zone data 28. For example, as the vehicle 100 approaches and enters the distraction zone 24, the distraction monitoring system 10 increases, or heightens, the sensitivity of the sensors 102. The heightened sensitivity of the sensors 102 is maintained throughout the duration of the vehicle 100 being within the distraction zone 24. Once the vehicle 100 leaves the distraction zone 24, the distraction monitoring system 10 may decrease the sensitivity of the sensors 102. Although the sensitivity of the sensors 102 may be decreased outside of the distraction zone 24, the sensors 102 still continuously monitor the vehicle 100 and the operator for potential distraction indicators 20, even outside of the distraction zone 24.

With further reference to FIGS. 1-3, the distraction event(s) 22 may also include a roadside event 22b. The roadside event 22b may be identified via the third-party data 200 received by the vehicle processor 12 via the network 202. The roadside event 22b may include, but is not limited to, third-party vehicle collisions, a vehicle on the side of the road, a vehicle stopped in the road, an on-road collision, and any other roadside event that may draw the attention of the operator. In some examples, the vehicle processor 12 may receive the third-party data 200 including the roadside event 22b and issue a distraction notification 26. The vehicle processor 12 may determine the distraction zone 24 based on the third-party data 200. It is contemplated that the vehicle processor 12 may categorize the third-party data 200 as the distraction zone data 28, as the third-party data 200 is typically utilized in determining the distraction zone 24 with respect to a roadside event 22b.

Once the distraction monitoring system 10 registers the distraction event 22, the distraction monitoring application 14 may be configured to anticipate the distraction data 130c and distraction indicators 20. For example, the distraction monitoring system 10 may determine and identify the distraction zone 24, and the distraction monitoring application 14 may anticipate the distraction data 130c based on the distraction zone 24. The distraction notification 26 that may be issued in response to the determined distraction zone 24 may include the anticipated distraction data 130c. For example, the distraction notification 26 may alert the operator that a roadside event 22b will be on a side of the road, but that the roadside event 22b is being handled by first responders and to maintain focus on driving the vehicle 100. After issuing the distraction notification 26, the vehicle processor 12 may heighten the sensitivity of the sensors 102 as the vehicle 100 approaches the distraction zone 24 to detect the potential distraction indicators 20.

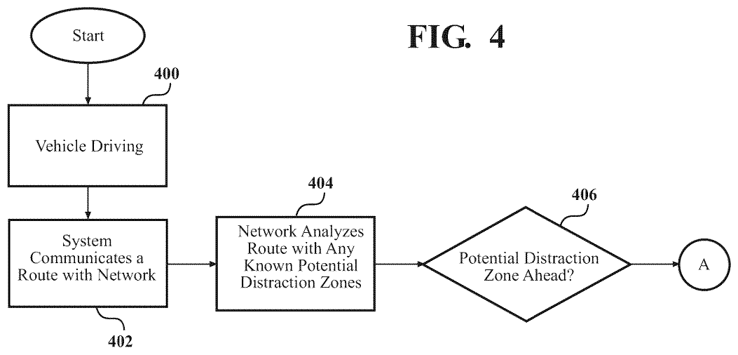

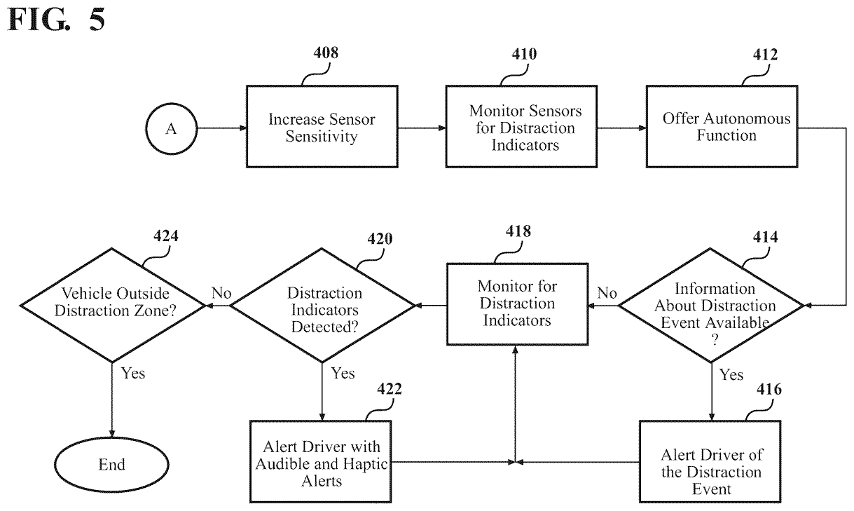

With reference to FIGS. 4 and 5, an example flow diagram for the distraction monitoring system 10 is depicted. The distraction monitoring system 10, at 400, detects that the vehicle 100 is driving, and the distraction monitoring system 10, at 402, communicates with the network 202 a route of the vehicle 100. The network 202, at 404, analyzes the route and compares the route with any known potential distraction zones 24. The distraction monitoring system, at 406, determines whether a potential distraction zone 24 is identified. If no distraction zone 24 is identified, the distraction monitoring system 10 continues to monitor the vehicle 100 along the route.

If a distraction zone 24 is identified, the distraction monitoring system 10, at 408, increases a sensitivity of the sensors 102 and, at 410, increases monitoring for distraction indicators 20. In some examples, the distraction monitoring system 10 may offer, at 412, the autonomous function 40 takeover. The distraction monitoring system 10, at 414, determines whether there is available data about the distraction event 22. If there is available data, the distraction monitoring system 10, at 416, alerts the driver of the distraction event 22 and, at 418, monitors the driver for distraction indicators 20. If there is no available data of the distraction event 22, the distraction monitoring system proceeds to monitoring for distraction indicators, at 418. The distraction monitoring system 10, at 420, determines whether distraction indicators 20 are detected. If distraction indicators 20 are detected, then the distraction monitoring system 10, at 422, issues audible and haptic alerts 26 to the driver, and returns to monitoring for distraction indicators 20, at 418. If no distraction indicators 20 are detected, then the distraction monitoring system 10, at 424, determines whether the vehicle 100 is outside of the distraction zone 24.

Referring again to FIGS. 1-5, the distraction monitoring system 10 assists vehicle operators in navigating through potential distraction zones 24 by providing context and information surrounding the potential distraction event 22. Further, the heightened sensitivity of the sensors 102 assists in maintaining focus on operating the vehicle 100 as the vehicle 100 passes through the distraction zone 24. In some instances, the vehicle 100 may include the autonomous functions 40, which may provide the operator with an opportunity to observe, for example, points-of-interest 22a that may otherwise be a distraction event 22. The distraction monitoring application 14 may prompt the operator with the option to execute the autonomous function 40 before the vehicle 100 is within the distraction zone 24. Additionally or alternatively, if the distraction monitoring system 10 detects the distraction indicators 20, the distraction monitoring application 14 may prompt the operator with the option to execute the autonomous function 40 while the vehicle 100 is within the distraction zone 24. The distraction monitoring system advantageously assists in maintaining driver focus during operation of the vehicle 100 where distraction events 22 may otherwise result in distraction indicators 20.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A distraction monitoring system for a vehicle, the distraction monitoring system comprising:
a plurality of sensors coupled to a body of the vehicle;
an audio array disposed within an interior cabin of the vehicle;
a vehicle processor including a distraction monitoring application, data processing hardware, and memory hardware storing vehicle data and distraction zone data, the vehicle processor being configured to receive sensor data from the plurality of sensors and being configured to issue a distraction notification in response to one or more of the distraction zone data and the sensor data; and
a network communicatively coupled to the vehicle processor and configured to provide third-party data to the distraction monitoring application.

2. The distraction monitoring system of claim 1, wherein the sensor data includes one or more of vehicle sensor data, impact avoidance data, and distraction data.

3. The distraction monitoring system of claim 2, wherein the distraction monitoring application is configured to anticipate the distraction data based on the distraction zone, the distraction notification including anticipated distraction data.

4. The distraction monitoring system of claim 2, wherein the vehicle processor is configured to heighten a sensitivity of the plurality of sensors in response to the vehicle approaching the distraction zone.

5. The distraction monitoring system of claim 1, wherein the third-party data includes points-of-interest and one or more roadside events.

6. The distraction monitoring system of claim 5, further including a GPS processor including GPS data, the network being configured to communicate the points-of-interest, the one or more roadside events, and the GPS data to the vehicle processor, the vehicle processor being configured to update the distraction zone data in response to receiving one or more of the points-of-interest, the one or more roadside events, and the GPS data.

7. The distraction monitoring system of claim 6, wherein the distraction monitoring application is configured to update the distraction zone based on the updated distraction zone data.

8. A distraction monitoring system comprising:
a plurality of sensors coupled to a body of a vehicle;
an audio array disposed within an interior cabin of the vehicle; and
a vehicle processor including a distraction monitoring application, data processing hardware, and memory hardware storing vehicle data and distraction zone data, the vehicle processor being configured to receive distraction data from the plurality of sensors and being configured to issue a distraction notification in response to one or more of the distraction zone data and sensor data received from the plurality of sensors.

9. The distraction monitoring system of claim 8, further including a network that includes a communication server that is communicatively coupled to the vehicle processor, the communication server configured to transmit third-party data to the vehicle processor.

10. The distraction monitoring system of claim 9, wherein the vehicle processor is configured to respectively update the distraction zone and heighten a sensitivity of the plurality of sensors in response to the third-party data received.

11. The distraction monitoring system of claim 9, further including a GPS processor including GPS data, the network being configured to communicate the third-party and GPS data to the vehicle processor, the vehicle processor being configured to update the distraction zone data in response to receiving at least one of the third-party data and GPS data.

12. The distraction monitoring system of claim 8, wherein the distraction monitoring application is configured to anticipate the distraction data from the plurality of sensors based on the distraction zone data, the distraction notification including anticipated distraction data.

13. The distraction monitoring system of claim 12, wherein the distraction data includes one or more points-of-interest, the distraction monitoring application configured to issue an audio notification via the audio array identifying the one or more points-of-interest.

14. The distraction monitoring system of claim 13, wherein the distraction monitoring application is configured to execute an autonomous function of the vehicle in response to the distraction data.

15. A vehicle distraction monitoring system comprising:
a plurality of sensors coupled to a body of the vehicle; and
a vehicle processor including a distraction monitoring application, data processing hardware, and memory hardware storing vehicle data, and distraction zone data, the vehicle processor being configured to receive vehicle sensor data and distraction sensor data from the plurality of sensors and being configured to issue a distraction notification in response to one or more of the distraction zone data, the vehicle sensor data, and the distraction sensor data, the vehicle processor configured to determine when the vehicle is approaching or disposed within a distraction zone and is configured to increase a sensitivity of one or more sensors of the plurality of sensors in response to the vehicle approaching or being disposed within the distraction zone.

16. The vehicle distraction monitoring system of claim 15, further including a network communicatively coupled to the vehicle processor, the vehicle processor configured to receive roadside event data and point-of-interest data from the network and, in response, update the distraction zone data.

17. The vehicle distraction monitoring system of claim 16, wherein the vehicle processor is configured to monitor driving patterns to detect a distraction event.

18. The vehicle distraction monitoring system of claim 17, wherein the vehicle processor is configured to issue one or more of audible alerts and haptic alerts in response to a detected distraction event.

19. The vehicle distraction monitoring system of claim 17, wherein the vehicle processor is configured to determine the distraction zone based on one or more of the distraction zone data, the point-of-interest data, and the roadside event data.

20. The vehicle distraction monitoring system of claim 19, wherein the vehicle processor is configured to determine when the vehicle is outside of the distraction zone and is configured to decrease a sensitivity of the one or more sensors of the plurality of sensors in response to the vehicle being outside of the distraction zone.
